(19) United States
(12) Patent Application Publication
(10) Pub. No.: US 2004/0129294 A1
(43) Pub. Date: Jul. 8, 2004

(54) Structure cleaning method and anticorrosion method, and structure using then

(76) Inventors: Tomoji Takamasa, Tokyo (JP); Koji Okamoto, Ibaraki (JP); Masahiro Furuya, Tokyo (JP)

Correspondence Address: Richard P Berg, Ladas & Parry, Suite 2100, 5670 Wilshire Boulevard, Los Angeles, CA, 90036-5679, US

(21) Appl. No.: 10/476,722

(22) PCT Filed: Apr. 26, 2002
(86) PCT No.: PCT/JP02/04226

(30) Foreign Application Priority Data
May 1, 2001 (JP) 2001-134233

(51) Int. Cl. B08B 7/00

(52) U.S. Cl. 134/1; 134/2; 134/42

(57) ABSTRACT

A cleaning method for removing deposition such as scale adhering to the surface of a structure and a structure using this are disclosed. A surface layer that contains a radiocatalyst 5 is provided on the surface of a structure 1. A contaminating substance adhered on said surface layer is decomposed, and/or adhesion of a contaminating substance onto said surface layer is inhibited by irradiating said surface with radiation. A structure corrosion prevention method is also disclosed. A surface layer that contains a radiocatalyst is provided on the surface of a structure, the corrosion potential of said surface being decreased by irradiating said surface with radiation.

### TECHNICAL FIELD OF THE INVENTION

The present invention relates to a cleaning method for removing contaminants such as scales that adhere onto the surface of structures, as well as a corrosion prevention method for the surface of structures, and structures using the same.

### DESCRIPTION OF THE RELATED ART

Scales, which are thin-layered solid precipitates, deposit onto the inner wall surface of structures after a long time has elapsed in structures in which water circulates, such as pipes and tanks. If the scales are left to sit, they provoke occlusion of piping and decrease the heat transferring ability of the pipe wall. Previously, in order to prevent adhesion of scales, a scale inhibitor was added to water.

However, even if a scale inhibitor is added, depending on the usage conditions and such, the formation of scales is not sufficiently prevented, and at the same time, depending on how the water will be used, there are cases in which scale inhibitors cannot be added.

In addition, a cleaning operation can be difficult for pipelines that are radioactive, such as pipelines used in nuclear devices, so much so that the pipelines must be replaced in case that scales are precipitated at an inner wall surface of pipelines. For this replacement, the operation of the nuclear reactor must be first stopped. Considering this, replacement operations cannot realistically be performed. This is why even if the amount of heat transfer of the pipe wall decreases, its utilization has to be continued.

This is not limited to structures in which scales accumulate, and generally there are cases where it is desirable to eliminate the contaminating substances on the surface of structures, or even eliminate the contaminants themselves. However, in cases where the structure is in a radioactive environment, there are instances where the surface of the structures are left unclean due to the dangers that accompany a cleaning operation of the surface of the structures.

The present invention was devised to solve these problems, and its objective is to provide a cleaning method that, while being of a simple constitution, removes contaminants such as scales that have adhered onto the surface of structures using a so-called radiocatalyst.

In addition, in nuclear reactor structures and such, a decrease in the corrosion potential has been attempted as a measure against corrosion or stress corrosion cracking of the welded spots.

For example, as a method to decrease the stress corrosion cracking of BWR structure materials, methods have been attempted in which hydrogen is injected into the cooling materials, and by having the structure materials retain noble metals, the corrosion potential is rendered lower than the threshold for the occurrence of stress corrosion cracking. However, the above-mentioned method is not effective.

Another objective of the present invention is to decrease the corrosion potential by using a so-called radiocatalyst.

### SUMMARY OF THE INVENTION

The technical means invented to solve the aforementioned problems are characterized by providing the surface of structures with a surface layer that contains a radiocatalyst, and by irradiating said surface to generate a redox reaction. The contaminating substance adhered onto said surface layer decomposes, and/or adhesion of the contaminating substances onto said surface layer is inhibited.

When the surface layer that contains the radiocatalyst is irradiated, an electron-hole pair is generated in the radiocatalyst, causing a redox reaction with oxygen and water adhered to said surface layer to generate active species. Then, such active species decompose the contaminating substances (scales, organic entities such as bacteria, etc.) adhered to the surface layer.

In the present invention, the surface layer that contains the radiocatalyst is in contact with fluid (a liquid or gas), and the present invention eliminates, at the boundaries between said surface layer and the liquid or gas, contaminating substances adhered to said surface layer in case that contaminants such as scales precipitate at the surface layer. With respect to said surface layer, said liquid or gas may be flowing (pipelines and such) or retained (tanks and such). When self-cleaning is considered, in one preferred example, it is advantageous to use a liquid, and at the interface between the structure surface and the liquid, the liquid is flowing with respect to the structure. Specifically, as an example, the inner wall surfaces of pipelines, which form the flow path of the liquid, constitute said surface layer.

In one preferred embodiment, the liquid is water, and the surface layer of the structure that contains the radiocatalyst is in contact with the water. In this case, when said surface layer is irradiated, it decomposes into superoxide anions and hydroxyl radicals to generate radicals from water by the radiocatalyst, and oxidatively decompose the contaminants that adhered to the surface of the structures.

As means to irradiate the surface layer of structures, in the case where irradiation is performed from the exterior of the structures, cases where the structures are placed in a radioactive environment may be cited, but it is not limited to these. In another preferred embodiment, the structure itself is exposed using a radiation source installed inside the structure (including the surface layer provided with said radiocatalyst). In case the surface layer of structures is formed by coating a material obtained by mixing a radiocatalyst and a radiation source, or, in case a radiation source is placed at a lower layer of the surface layer and installed inside the structures, the surface of structures can be cleaned without irradiating from the exterior. In this specification, the case where radiation is not supplied from the exterior in this way, and the base materials or the coating on the surface of the base materials is activated and/or radioactive substances are retained, is called the self-excitation method. The self-excitation method is effective not only in the cleaning method but also in the anti-corrosion method described later.

In the present specification, a radiocatalyst is a substance in which electrons are excited and conduction electrons and positive holes are generated when irradiated with radiation such as γ-rays or X-rays. In other words, the aforementioned radiocatalyst designates a substance which demonstrates radiation-induced surface activation, that is, a catalyst that promotes redox reactions by irradiation. In addition, radiation-induced surface activation is the phenomenon in which the redox reaction on the surface of the substance is promoted by irradiation. The present invention performs treatment of the surface of structures by using the effects of radiation-induced surface activation to perform cleaning and corrosion prevention of surfaces of structures. In the present specification, radiation includes α-ray, β-ray, and neutron radiation. In addition, since radiation can pass through objects, radiation can be provided from outside a system, even if the radiocatalyst is inside a structure, such that the range of application of the present invention is broad.

As one preferred concrete example of a radiocatalyst, titanium oxide (including anatase type and rutile type) may be cited. However, radiocatalysts are not limited to titanium oxide. Related to radiocatalysts using the energy of radiation to decompose water into superoxide anions and hydroxy radicals, it is believed that a semiconductor whose lower end of the conduction band is situated more on the minus side of the hydrogen generation potential (0V) from water and whose upper edge of the valence band is situated more on the plus side of the oxygen generation potential (1.23V), could be used as the radiocatalyst. SrTi0₃, CdSe, KTa_{0.77}Nb_{0.23}0₃, KTa0₃, CdS, ZrO₂ may be indicated as examples. In addition, since the radiation rays used with these radiocatalysts have larger excitation energies compared to ultra-violet rays and such, it is believed that substances whose band gap is larger than the substances used as photocatalysts in the prior art could also be used. Accordingly, oxide films (titanium oxide, the oxide film of stainless steel, zirconium oxide, alumina, etc.) formed on the surface of metal base materials (for example, titanium, stainless steel, zircalloy aluminum, etc.) may also constitute radiocatalysts. As means to form such oxide films, a high-temperature plasma may be used on the surface of metals, and form an oxide film on the metal surface from the oxygen present in the air. Or, a film of metal oxides (for example, titanium oxide, zirconium oxide, aluminum oxide (alumina)) may be formed on the surface of base materials (structures) by evaporative oxidation or oxidation during autoclave, by the spraying, CVD, PVD (including sputtering), dipping and spray coating. In case electron-hole pairs are generated by irradiation, even insulators may constitute radiocatalysts. Furthermore, elements of the platinum group such as ruthenium may be retained in radiocatalysts. By retaining elements of the platinum group such as ruthenium, recombination is inhibited, and charge separation efficiency can be increased.

In addition, not only the metal oxides mentioned above but nitrides and carbides may also constitute radiocatalysts. Here, concrete examples of substances that constitute the radioactive substances are given as follows: Al₂0₃, Ti0₂, Fe₂0₃, Zn0, Y₂0₃, Mn0₂, Nd₂0₃, CeO₂ and ZrO₂ for oxides; AlN, CrN, Si₃N₄, BN, Mg₃N₂ and Li₃N for nitrides; Al₄C₃, UC, U₂C₃, UC₂, CaC₂, SiC, ZrC, W₂C, WC, TaC, TiC, Fe₃C, HfC, B₄C and Mn₃C for carbides. Radiocatalysts may be constituted of one or more than 2 compounds selected from these substances.

As described above, the present invention uses oxides that, when excited by radiation, decompose and eliminate contaminating substances that have adhered to the surface of structures. However, upon closer study, it has been discovered that when a surface layer that contains the radiocatalyst is irradiated, said surface layer displays hyper-hydrophilicity (wettability increases) (International Publication No. WO01/33574). Therefore, in the case where said surface layer is in contact with water (including the case where the contact is normal, and the case where the contact is temporary), at the same time as active species are obtained by decomposing said water, it is believed that the present invention has the action of eliminating said contaminants by the fact that said water infiltrates between the hyper-hydrophilic surface and the contaminant, or the action of accumulation of contaminating substances on the surface of structures becomes more difficult by the fact that the water adheres to the surface of the structures.

Summarizing here the efficacy of the self-cleaning action gives the following two points: first, the effect of cleaning is due to hydrophilicity, wherein a liquid film of adsorbed water and such exists on the surface of structures, so as to easily wash away contaminants, making it difficult for contaminating substances to adhere, or, to easily peel off adhered contaminating substances. The other effect is the decomposition of the surface contaminants due to redox reactions, wherein organic compounds, scales and such that have adhered to the surface of structures are decomposed by being oxidized/reduced and are separated from said surface.

In addition, when the surface of structures that contain a radiocatalyst is irradiated, there is also a corrosion-prevention action, wherein an anode current runs in the host materials due to a strong reduction reaction, and the corrosion potential of the surface of structures is decreased. A description was given above regarding radiocatalysts in which metal oxides and metal oxide films were indicated as examples of radiocatalysts, more specifically, oxide films of titanium oxide, zirconium oxide, aluminum oxide (alumina) and stainless steel. Metal oxides may consist of insulators. In addition, it goes without saying that the radiocatalysts that are provided on the surface of structures are not limited to one type of radiocatalyst, and may be a compound of two or more types of radiocatalysts. In the titanium oxide and zirconium oxide experiments (described later), it was shown that the corrosion potential decreases due to γ-ray irradiation. In addition, this result was also obtained with alumina.

As described above, in one preferred example of the present invention, the surface of structures is in contact with water. However, in such an environment, corrosion of the surface of structures may become a problem. However, in the present invention, in the case of irradiation of the surface of structures, not only decomposition of the contaminating substances that have adhered on said surface, but an anti-corrosion effect on said surface is also achieved. In addition, this anti-corrosion effect is not limited to cases where structures are directly in contact with water, but is also advantageous in case the surfaces of structures are exposed to an air environment or vapor environment. Furthermore, this anti-corrosion effect can be taken independently from the cleaning of the surface of structures, in particular, by providing a radiation source inside structures, it is also possible to provide a corrosion prevention method for structures other than those under a radioactive environment such as nuclear devices.

As suitable examples of structural members in which the anti-corrosion method related to the present invention may be applied, structural members of a nuclear reactor, nuclear fusion structure materials, ship's hulls, spaceships, casks (including transport containers for radioactive substances, transport containers diverted into storage containers, large and heavy class storage containers for radioactive substances used inside nuclear reactor facilities) and canisters, and other storage containers to perform medium to long-term storage of other radioactive substances, etc., may be cited, and these may be used to reduce corrosion or stress corrosion cracking of the welded spots.

### BRIEF DESCRIPTION OF THE DRAWINGS

FIG. 1 is a partial cross-sectional view showing an embodiment pertaining to the present invention;

FIG. 2 is a partial cross-sectional view showing another embodiment pertaining to the present invention;

FIG. 3 shows the variation in electric potential when an iron sample fragment onto which ZrO₂ has been sprayed is irradiated with γ-rays;

FIG. 4 shows the variation in electric potential when an iron sample fragment onto which TiO₂ has been sprayed is irradiated with γ-rays;

FIG. 5 shows the variation in electric potential when an iron sample fragment onto which ZrO₂ has been sprayed is irradiated with γ-rays, and when an iron sample fragment onto which ZrO₂ has been sprayed is activated for one week; and

FIG. 6 shows the variation in electric potential when an iron sample fragment onto which TiO₂ has been sprayed is irradiated with γ-rays, and when an iron sample fragment onto which TiO₂ has been sprayed is activated for one week.

### DETAILED DESCRIPTION OF THE PREFERRED EMBODIMENTS

A. Cleaning Method

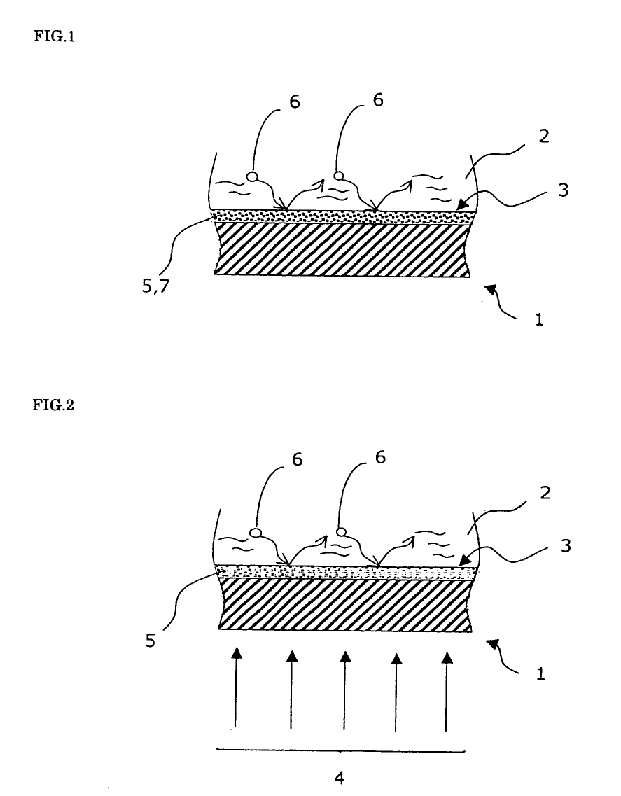

The constitution of the present invention will be described based on the embodiments shown in the drawings. The structure of the present invention is formed by providing a radiocatalyst 5 at the contact surface 3 with water 2, which cleans the contact surface 3 with the active species generated by receiving radiation 4 and decomposing water 2. When the contact surface 3 of a structure 1 and water 2 is irradiated with radiation 4, water 2 is decomposed by the radiocatalyst 5, superoxide anions and hydroxy radicals are generated, which then oxidize or reduce scales 6 that have adhered onto the surface of the structure 1, and decompose them. In this way, scales 6 can be removed from the contact surface 3 between the structure 1 and water 2 for cleaning, and occlusion and such of piping due to adhesion of scales 6 and such can be prevented. In FIG. 1 and FIG. 2, the contact surface 3 that is shown is formed by the entire surface of structure 1 in contact with water 2. However, the present invention can be applied also in such cases where the structure is placed in air, and adsorbed water exists on the surface of said structure. The surface of the structure is cleaned by the active species generated by the decomposition due to irradiation of adsorbed water on the surface of structures.

In the embodiment shown in FIG. 1, radiocatalyst 5 is kneaded together with radioactive substance (radiation source) 7 to form the surface layer of structure 1. Therefore, since the radiocatalyst 5 can be activated using the radiation from a radiation source 7 contained in the surface layer, cleaning can be performed even without irradiating structure 1 with the radiation 4 from the exterior. In the embodiment, titanium oxide is used as the radiocatalyst 5.

For example, one or several among α-ray sources, β-ray sources and γ-ray sources is/are selected as the radiation source 7, ⁶⁰Co being given as an example of a γ-ray source. In addition, radioactive wastes may be used as radiation sources. Then, the radiocatalyst 5 and radiation source 7 are mixed and used to coat the contact surface 3 of the structure 1.

According to the structure 1 described above, since the radiocatalyst 5 is normally receiving radiation from the radiation source 7, cleaning of the contact surface 3 is performed by the contact of water 2 with the structure 1. Since there is no need to irradiate structure 1 from the exterior with radiation 4, the installation for cleaning can be simplified.

FIG. 2 shows another embodiment, in which only radiocatalyst 5 is applied on the contact surface 3 of the structure 1 while irradiating with radiation 4 from the exterior of the portion where application was performed. In this embodiment, for example, if the structure 1 receives the radiation 4 from a nuclear device, cleaning of the surface of the structure can be performed by using the radiation 4.

Nothing in particular limits the structure 1, but this is applicable to all structures in which scales 6 occur by contact with water such as pipelines, tanks and such used in heat exchangers (including condensers), hot water suppliers, and nuclear devices to give a few preferred examples. For heat exchangers and hot water suppliers that are normally not in a radioactive environment, it is advantageous to mount a radiation source inside the structure.

As it is clear from the above description, according to the present invention, due to the generation of active species by irradiation, contaminants that have adhered to the surface of structures can be adequately eliminated In addition, adhesion of contaminants on the surface of structures can be inhibited. Furthermore, the redox potential generated by the irradiation being greater compared to that of photocatalysts, the cleaning of the surface of structures can be improved. Also, as described later, due to a stronger redox potential, the corrosion-prevention effect at the surface of structures also increases.

According to the present invention, in particular in the case when the surface of structures is in contact with water, the scales that have adhered onto the surface of structures can be adequately decomposed, without using a scale inhibitor or replacing structures. In addition, since the surface of structures become hyper-hydrophilic due to the irradiation, the scales that are decomposed are easily washed away by water.

In the case of a radiation source being included inside the structure, the cleaning of the surface of the structure can be performed even if the structure is not irradiated from the exterior, allowing cleaning of the surface of structures to be achieved with a simple installation.

B. Corrosion Prevention Method

Next, weakening of the corrosion potential using a radiocatalyst will be described.

[Experiment 1]

A test fragment was prepared by spraying approximately 220 μm thick titanium oxide as a metal film on the surface of a 1 mm-thick, 20 mm-wide, and 50 mm-long iron plate with 99.99% purity. In order to observe corrosion of the entire surface, the back face and the edge portions were coated with araldite. The test fragment was placed in a glass container with an inner diameter of 33 mm, and as a first step, in order to promote corrosion, 50 ml of a 3 wt % sodium chloride aqueous solution was added. In addition, the concentration of dissolved oxygen was saturated. As the source of radiation, γ-rays was used, however, for comparative tests, the same tests were carried out using an ultra-violet source and a non-irradiation control (kept in darkroom). The test parameters were the radiation dose rate (300 Gy/h-900 Gy/h) and the accumulation time (16-64 h). ⁶⁰Co was used as the γ-ray source. The ultra-violet lamp used had a central wavelength of 352 nm, and the power was approximately 5.0 mW/cm² in the UV-A in the present experiment.

Visual observation of the surface and determination of the concentration of iron ions in the aqueous solution were performed. Hydroxides on the surface were eliminated by subjecting to ultrasonic cleaning treatment for 10 minutes and after vacuum drying for 20 minutes, a photograph was taken, and surface observation was performed based on the photographs. The case where the sample was kept in the darkroom and the case where irradiation was by ultra-violet rays were similar and corrosion proceeded nearly all over the surface of those for which a partial pitting corrosion was observed. On the other hand, the case where irradiation was by γ-rays, such corrosive behavior was almost not found. This is believed to be due to the fact that the orbital electrons including the valence band were excited by the conduction band due to the γ-ray, and that the corrosion potential was weakened, exhibiting a corrosion attenuation effect. In addition, experiments were performed in which the solution immersion times were 40 h and 64 h, and the results showed that corrosion proceeded in the case of the darkroom, but the progress of corrosion was slower in the case of γ-ray irradiation.

To determine the concentration of iron ion in the solution, the supernatant of the solution was collected, bivalent iron ions were colored with o-phenanthroline to generate a colored solution, and quantified using a Hitachi spectrophotometer U-2010. Trivalent iron ions were reduced using ascorbic acid and colored as above, measured as the sum of the concentrations of bivalent and trivalent iron ions, and the difference with the previously mentioned result was taken as the concentration of trivalent iron ions. It was shown that in the case of irradiation by γ-ray, the proportion of trivalent iron ions was greater. This is believed to be due to the generated oxygen radicals reducing the bivalent iron ions. The major portion of the products of corrosion is sedimented as solids such as hydroxides. The solid sediments were not analyzed, however, their amounts were notably less for the sample fragment irradiated with γ-rays.

Experiments were also carried out regarding the influence of the γ-radiation dose rate. The test fragment was immersed for 16 h in a 3 wt % sodium chloride aqueous solution. Pitting corrosion and overall corrosion were clearly observed concomitant to the decrease of the dose rate. From this, it became clear that a higher corrosion attenuation effect could be expected by increasing the dose rate.

[Experiment 2]

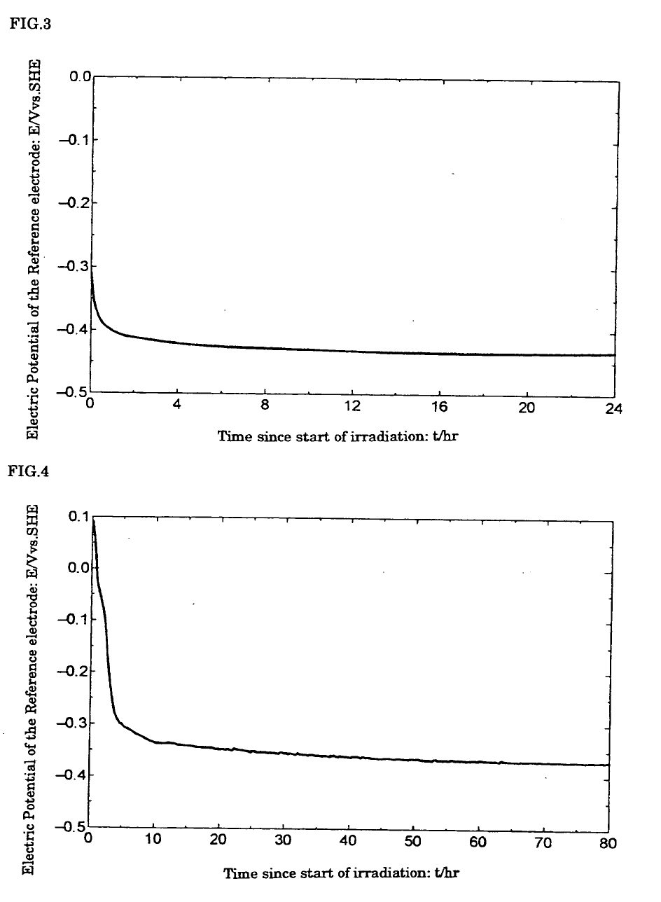

Corrosion potentials were measured for zirconium oxide and titanium oxide. ⁶⁰Co (600 Gy/h) was used as the γ-ray source, iron plates whose surfaces were coated with zirconium oxide and titanium oxide respectively were used as test fragments, and a 3 wt % sodium chloride aqueous solution was used to promote corrosion. FIG. 3 shows the variation in the electric potential when an iron sample fragment sprayed with zirconium oxide was irradiated with γ-rays. FIG. 4 shows the variation in the electric potential when an iron sample fragment sprayed with titanium oxide was irradiated with γ-rays. From the figures, it is clear that the corrosion potential is weaker for the sample sprayed with zirconium oxide (−0.43 V), than the sample sprayed with titanium oxide (−0.37 V).

[Experiment 3]

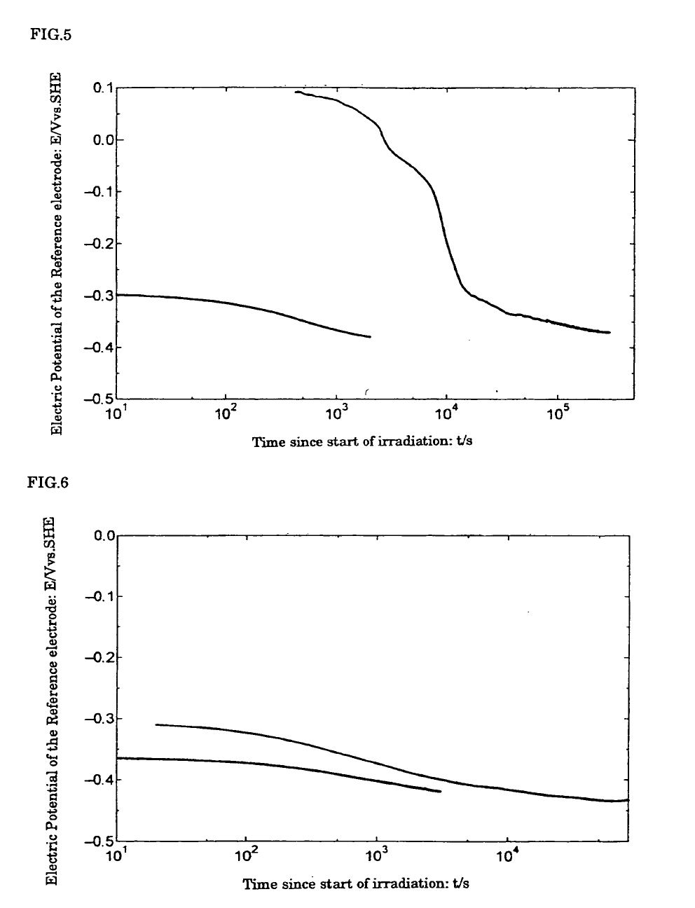

The variation in electrical potential was measured on self-excited samples. The test fragments used were iron plates whose surfaces were coated with titanium oxide and zirconium oxide respectively, and a 3 wt % sodium chloride aqueous solution was used for to promote corrosion. Sample fragments that were radio-activated by neutron irradiation for one week were used to measure the variation in electric potential. The results of this measurement were compared to the results of the measurements in Experiment 2 and shown in the Figure. FIG. 5 shows the variation in electric potential when the iron sample fragment sprayed with titanium oxide is irradiated by γ-rays (upper-right graph), and the iron sample fragment sprayed with titanium oxide radio-activated by neutron irradiation for one week (lower-left graph). FIG. 6 shows the variation in electric potential when the iron sample fragment sprayed with zirconium oxide is irradiated by γ-rays (upper graph), the iron sample fragment sprayed with zirconium oxide radio-activated by neutron irradiation for one week (lower graph). Since the self-excited samples and the samples irradiated with γ-rays differ in the order of magnitude of the time until stabilization of the electrical potential, the time axis is represented as a logarithm to show them on the same graph. For the samples of Experiment 2, it takes 24 hours after irradiation to stabilize the corrosion potential, however, for the self-excited samples, the electrical potential stabilizes with a shorter time (10 minutes, for example). As is clear from FIGS. 5 and 6, the voltage at which stabilization is reached is approximately the same for the self-excited samples and the samples irradiated by γ-rays. In addition, the iron sample fragment obtained by the self-excitation method was 1 mm thick, 20 mm wide and 50 mm long, was radio-activated by neutron irradiation for one week, and then removed, and the corrosion potential was measured one week after. The surface dose at that time was 2 μSv/h, and it is clear that the anti-corrosion effect can be obtained with a relatively small radio-activation.

### INDUSTRIAL APPLICABILITY

The cleaning method pertaining to the present invention can be used to eliminate scales in structures such as pipelines that are used in nuclear devices. The corrosion prevention method pertaining to the present invention can be used in the prevention of stress corrosion cracking of nuclear reactor shrouds and corrosion prevention for welding spots of various structures.

What is claimed is:

1. A structure cleaning method wherein a surface layer that contains a radiocatalyst is provided on the surface of a structure, a contaminating substance adhered on said surface layer is decomposed, and/or adhesion of a contaminating substance onto said surface layer is inhibited by irradiating said surface with radiation.

2. The structure cleaning method of claim 1, wherein said surface of structure layer is in contact with water.

3. The structure cleaning method of either of claim 1 or claim 2, wherein a radiation source is provided inside said structure.

4. A structure, which is a structure placed in a radioactive environment, the surface of said structure having a surface layer that contains a radiocatalyst, and constituted in such a way that a contaminating substance adhered on said surface layer is decomposed and/or, adhesion of a contaminating substance onto said surface layer is inhibited by irradiating said surface with radiation.

5. The structure of claim 4, wherein said surface layer is in contact with water.

6. The structure cleaning method of either of claim 4 or claim 5, having a radiation source inside said structure.

7. The cleaning method of either of claim 1 through claim 3, wherein the radiocatalyst comprises one type or any combination of two or more types selected from:
Al₂O₃, Ti0₂, Fe₂0₃, ZnO, Y₂0₃, Mn0₂, Nd₂0₃, Ce0₂, Zr0₂, AlN, CrN, Si₃N₄, BN, Mg₃N₂, Li₃N, Al₄C₃, UC, U₂C₃, UC₂, CaC₂, SiC, ZrC, W₂C, WC, TaC, TiC, Fe₃C, HfC, B₄C and Mn₃C.

8. A structure corrosion prevention method, wherein a surface layer that contains a radiocatalyst is provided on the surface of a structure, the corrosion potential of said surface being decreased by irradiating said surface with radiation.

9. The corrosion prevention method of claim 8, wherein said radiocatalyst is a metal oxide.

10. The corrosion prevention method of claim 9, wherein said metal oxide is an insulator.

11. The corrosion prevention method of claim 10, wherein said metal oxide is alumina.

12 The corrosion prevention method of either of claim 8 through claim 11, wherein a radiation source is provided inside said structure.

13. The corrosion prevention method of claim 8, wherein the radiocatalyst comprises one type or any combination of two or more types selected from:
Al₂O₃, Ti0₂, Fe₂0₃, ZnO, Y₂0₃, Mn0₂, Nd₂0₃, Ce0₂, Zr0₂, AlN, CrN, Si₃N₄, BN, Mg₃N₂, Li₃N, Al₄C₃, UC, U₂C₃, UC₂, CaC₂, SiC, ZrC, W₂C, WC, TaC, TiC, Fe₃C, HfC, B₄C and Mn₃C.

14. A structure, which is a structure placed in a radioactive environment, having a surface layer that contains a radiocatalyst, and constituted in such a way that the corrosion potential of said surface is decreased by irradiating said surface.

15. The structure of claim 14, wherein said radiocatalyst is a metal oxide.

16. The structure of claim 15, wherein said metal oxide is an insulator.

17. The structure of claim 16, wherein said metal oxide is alumina.

18. The structure of either of claim 14 through claim 17, wherein a radiation source is provided inside said structure.

19. The structure of either of claim 14 through claim 18, wherein said structure is selected from the group consisting of a nuclear reactor structural member, a nuclear fusion structure material, a ship's hull, a spaceship, a cask, a canister or other storage container that performs mid to long-term storage of a radioactive substance.
